(19) United States
(12) Patent Application Publication
(10) Pub. No.: US 2009/0002467 A1
(43) Pub. Date: Jan. 1, 2009

(54) FLUID EJECTING APPARATUS AND METHOD FOR CONTROLLING THE SAME

(75) Inventor: Eiichiro Watanabe, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/163,736

(22) Filed: Jun. 27, 2008

(30) Foreign Application Priority Data
Jun. 28, 2007 (JP) 2007-170876
Apr. 23, 2008 (JP) 2008-113046

(51) Int. Cl. B41J 2/175

(52) U.S. Cl. 347/89

(57) ABSTRACT

A fluid ejecting apparatus including a head having a nozzle for ejecting fluid, a storing section that stores the fluid, a pressurizing section that applies pressure to the fluid so that the fluid flows from the storing section to the head, a discharge passage through which the fluid may be discharged from the head without passing through the nozzle, a valve provided in the discharge passage, a reservoir connected to the end of the discharge passage, and a circulating passage which connected to the end of the discharge passage which is connected to the storing section. The fluid ejecting apparatus has an ejection mode where the fluid is ejected from the nozzles, a discharge mode where the fluid is discharged to the reservoir, and a circulation mode where the fluid is discharged to the storing section through the circulating passage.

The entire disclosure of Japanese Patent Application No. 2007-177876, filed Jun. 28, 2007 and Japanese Patent Application No. 2008-113046, filed Apr. 23, 2008 are expressly incorporated herein by reference.

### BACKGROUND OF THE INVENTION

1. Technical Field

The present invention relates to a fluid ejecting apparatus. More specifically, the present invention relates to a system and method for controlling the fluid within a fluid ejecting apparatus.

2. Related Art

One example of fluid ejecting apparatuses currently known in the art comprises an ink jet printer that is capable of printing on various media, such as paper, cloth, and film, by ejecting a fluid (ink) thereon. Typically, the printers are equipped with a head having a plurality of nozzles that eject the fluid, a series of channels through which the fluid is sent to the nozzles, and a storing section that stores the fluid supplied to the head. Generally, the fluid supplied from the storing section is supplied to the head through the plurality of channels, such as in the fluid ejecting apparatus disclosed in Japanese Patent No. JP-A-11-207993.

One problem with such fluid ejecting apparatuses, however, is that the nozzle may become clogged with fluid. In such instances, the clogs cause troubles such as missing dots during the printing operation, making it necessary to eliminate the fluid causing the clogging.

Furthermore, in the structure in which fluid is sent to the nozzles through the channels in the head, the condition of the channel sometimes deteriorates. For example, when the head is not used for a long time, fluid in the channel sometimes increases in viscosity. Then, when fluid is sent to the nozzle through the channel, the fluid may be supplied to the nozzle at a different pressure or rate than normal, causing printing errors.

### BRIEF SUMMARY OF THE INVENTION

An advantage of some aspects of the invention is that the nozzles are prevented from being clogged, so that the recording head channel is maintained in good condition.

One aspect of the invention is a fluid ejecting apparatus including a head having a nozzle that is capable of ejecting fluid and a channel through which the fluid flows to the nozzle, a storing section that is capable of storing the fluid supplied to the head, a pressurizing section that applies pressure to the fluid so that the fluid flows from the storing section to the head, a discharge passage connected to the channel through which the fluid flows without passing through the nozzle, a valve provided in the discharge passage, a reservoir connected to the discharge passage that is downstream from the valve which is capable of storing the fluid discharged from the head, and a circulating passage which is connected to the discharge passage and the storing section at a location that is downstream from the valve.

A second aspect of the invention is a method for controlling the fluid ejecting apparatus described above, the method comprising ejecting the fluid from the nozzle by applying pressure to the fluid using the pressurizing section with the valve closed, opening the discharge passage with the valve so that the fluid discharged from the head flows from the head to the reservoir, and opening the discharge passage with the valve so that the fluid discharged from the head flows from the head to the storing section through the circulating passage. As described more fully below, one advantage of the system and method of embodiments of the invention is that the fluid ejecting apparatus can eliminate clogs from forming in the nozzle and can maintain the channels in a usable condition.

Other features of the invention will be apparent from the following description and the accompanying drawings.

At least the following will be apparent from the following description and the accompanying drawings.

### BRIEF DESCRIPTION OF THE DRAWINGS

The invention will be described with reference to the accompanying drawings, wherein like numbers reference like elements.

FIG. 1 is a block diagram showing the overall structure of a printer according to an embodiment of the invention;

FIG. 2A is a sectional view of the printer;

FIG. 2B is a diagram showing a state wherein the printer is transporting paper;

FIG. 3 is a schematic diagram showing a nozzle array on the lower surface of a head;

FIG. 4 is a diagram showing a state in which ink is ejected from the nozzles during a nozzle cleaning operation;

FIG. 5 is a diagram showing a state wherein ejected ink is sent to a waste ink tank;

FIG. 6 is a diagram showing a state wherein the ejected ink is sent to an ink cartridge;

FIG. 7 is a flowchart for describing a method of controlling a cleaning operation according;

FIG. 8 is a schematic diagram of an ink supply unit and an ink collection unit according to a second embodiment;

FIG. 9 is a schematic diagram of an ink supply unit and an ink collection unit according to a third embodiment;

FIG. 10 is a diagram showing another embodiment of the head unit;

FIG. 11 is a diagram showing another embodiment wherein the ink discharged from the head is sent to a waste ink tank; and

FIG. 12 is a flowchart for describing a modified method of performing a cleaning operation according to another embodiment of the invention.

### DESCRIPTION OF EXEMPLARY EMBODIMENTS

### Line Head Printer

The fluid ejecting apparatus will be described using an ink jet printer as an example of a fluid ejecting apparatus capable of performing aspects of the invention. More particularly, the structure and processes of a line head printer (hereinafter, simply referred to as a printer 1) will be described as an example of an ink jet printer capable of performing aspects of the invention.

### Structure of Printer

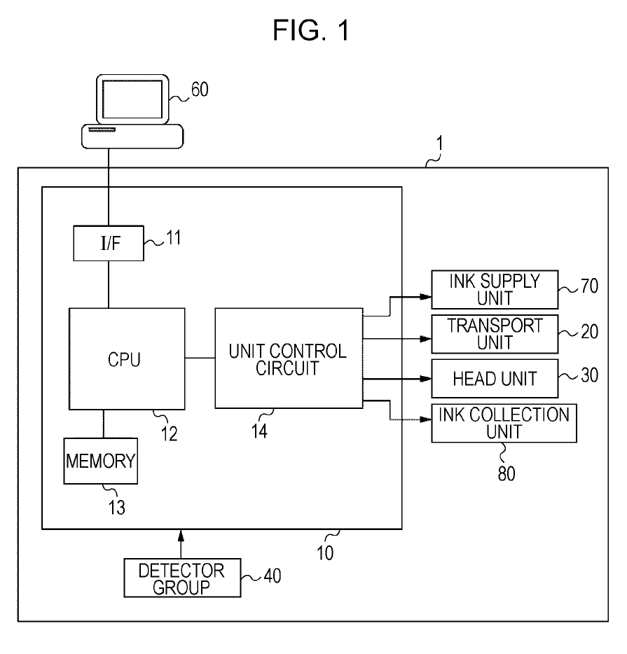

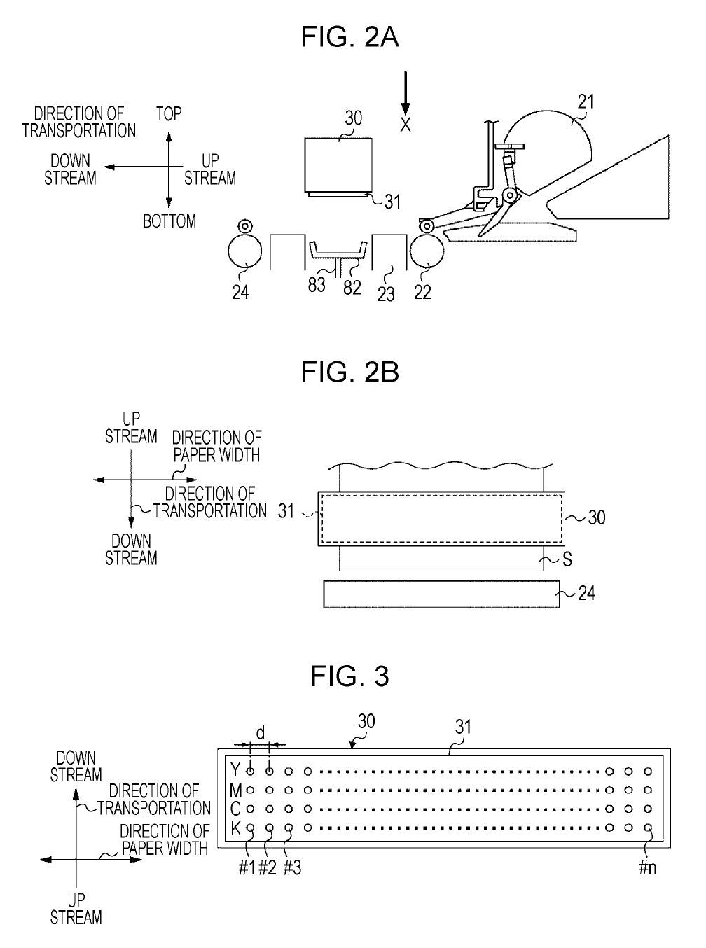

The structure of the printer 1 will be described with reference to FIGS. 1, 2A, 2B, and 3. FIG. 1 is a block diagram showing the overall structure of the printer 1 according to an embodiment of the invention. FIG. 2A is a sectional view of the printer 1, FIG. 2B is a diagram showing a state wherein the printer 1 is transporting paper S (medium). FIG. 3 is a schematic diagram showing a nozzle array on the lower surface of a head 31. FIG. 2B shows a head unit 30 and other components as viewed from the direction X in FIG. 2A.

Upon receiving print data from an external computer 60, the printer 1 controls various units (a transport unit 20, the head unit 30 and so on) using a controller 10 in order to form an image onto the paper S. A detector group 40 monitors the state in the printer 1. The controller 10 controls the units according to the detection results.

The controller 10 is a control unit for controlling the printer 1. An interface 11 sends and receives data between the external computer 60 and the printer 1. A CPU 12 is a processing unit for controlling the processes of the printer 1. A memory 13 comprises an area for storing and executing the programs of the CPU 12. The CPU 12 controls the units with a unit control circuit 14 according to the programs stored in the memory 13.

The transport unit 20 feeds the paper S to a printable position and transports a fixed amount of the paper S in the transportation direction when printing. As shown in FIG. 2A, the transport unit 20 includes a paper feed roller 21, a transport roller 22, a platen 23, and a paper output roller 24. The paper feed roller 21 is a roller for feeding the paper S inserted into a paper slot into the printer 1. The transport roller 22 is a roller for transporting the paper S fed by the paper feed roller 21 to a printable area. The platen 23 supports the paper S being printed. The paper output roller 24 is a roller for expelling the paper S out of the printer 1.

The head unit 30 is a unit for ejecting ink, or fluid, onto the paper S. The head unit 30 ejects ink onto the paper S as it is transported through the printer 1 in the form of dots, thereby printing an image on the paper S. The head unit 40 according to the embodiment can form dots along the entire width of paper at the same time. The ink may be either a water-based ink or oil-based ink.

The head unit 30 includes the head unit 30. As shown in FIG. 3, the head 31 has four nozzle trains—a black-ink nozzle train (nozzle train K), a cyan-ink nozzle train (nozzle train C), a magenta-ink nozzle train (nozzle train M), and a yellow-ink nozzle train (nozzle train Y). The nozzle trains each have a plurality of (n) nozzles arrayed at a regular intervals d along the width of the paper. The nozzles are numbered from #1 to #n, from the left to the right in the drawing. The nozzles are each provided with a pressure chamber (not shown) containing ink and a driving element (piezoelectric element) which is capable of ejecting the ink by changing the capacity of the pressure chamber.

### Printing Job

The printing job of the printer 1 of the above structure will now be described. Upon receiving a print instruction and print data from the computer 60, the controller 10 analyzes the contents of the various commands in the print data and executes the following process.

First, the controller 10 rotates the paper feed roller 21 in order to feed the printing paper S into the printer 1. The controller 10 then rotates the transport roller 22 to move the fed paper S to a print start position. At that time, the paper S faces at least part of the nozzles of the head 31.

The paper S is transported by the transport roller 22 at a constant speed without stopping as it passes below the head 31 (over the platen 23). As the paper S passes below the head 31, ink is intermittently ejected from the nozzles. As a result, dot trains (raster lines) comprised of multiple dots along the direction of transportation are formed on the paper S. Finally, the controller 10 outputs the paper S with the printed image, by the paper output roller 24.

### Structure of Ink Supply Unit and Ink Collection Unit

The ink in the head 31 is depleted by the execution of the printing job. Accordingly, the printer 1 is equipped with an ink supply unit 70 (see FIG. 1) that supplies ink to the head 31. Furthermore, when the head 31, or nozzles, are cleaned, ink is also ejected from the nozzles. Accordingly, the printer 1 is equipped with an ink collection unit 80 (see FIG. 1) for collecting the ink.

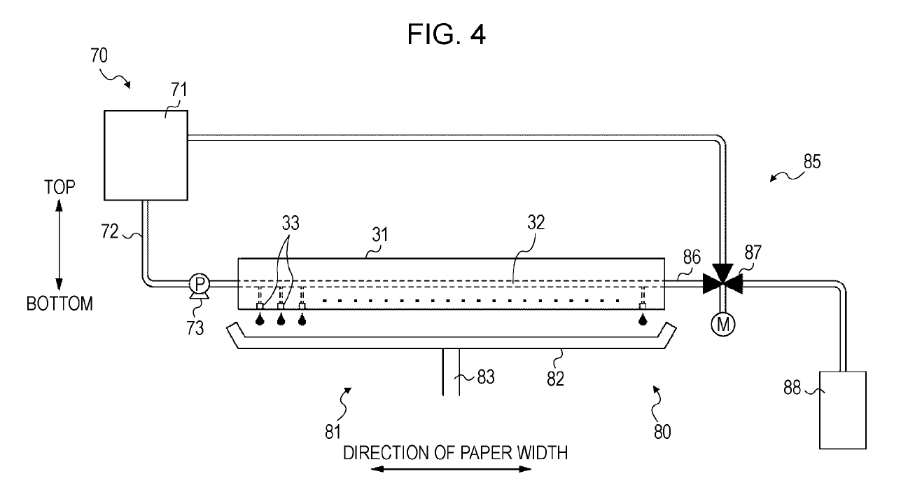

An ink supply unit 70 and ink collection unit 80 are provided for each color. For example, the printer 1 has an ink supply unit 70 that supplies yellow ink and an ink collection unit 80 that cleans the nozzle train Y. The structure of the ink supply units 70 and the ink collection units 80 are substantially the same for all the colors. Accordingly, the detailed structure of the yellow ink supply unit 70 and the yellow ink collection unit 80 will be described with reference to FIGS. 4 to 6.

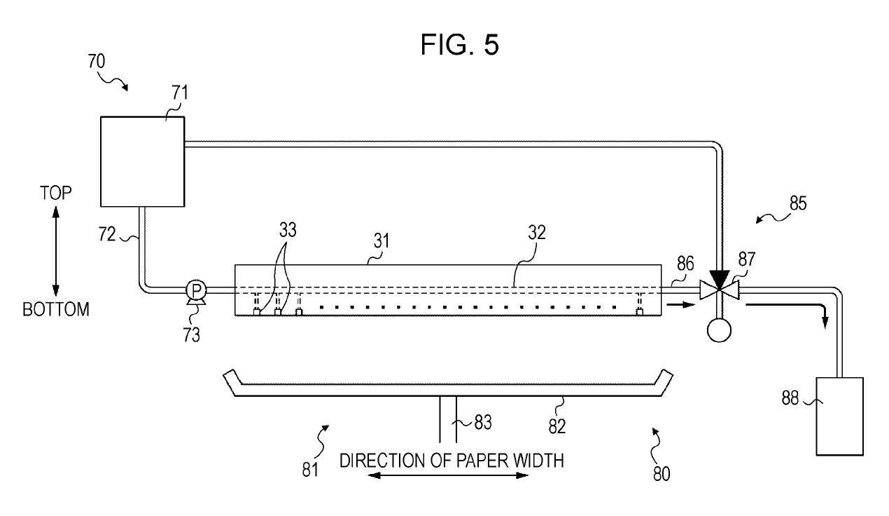

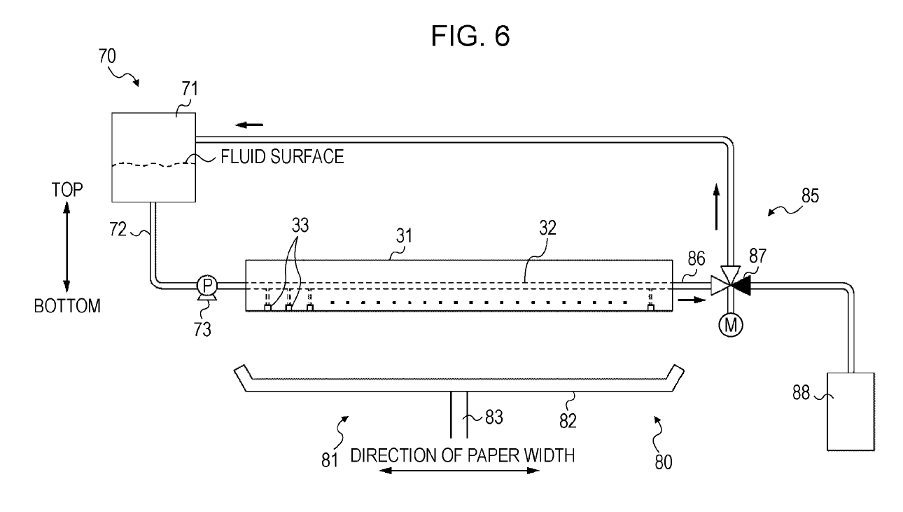

FIGS. 4 to 6 are schematic diagrams showing the head 31, the ink supply unit 70, and the ink collection unit 80. FIG. 4 shows a state wherein ink is ejected from the nozzles during a nozzle cleaning process FIG. 5 shows a state wherein the ink ejected from the head 31 is sent to a waste ink tank 88. FIG. 6 shows a state wherein the ink discharged from the head 31 is sent to an ink cartridge 71.

### Structure of Ink Supply Unit

The ink supply unit 70 includes the ink cartridge 71, a supply passage 72, and a supply pump 73.

The ink cartridge 71 is a storage section that stores the ink supplied to the head 31. The supply passage 72 is connected to the ink cartridge 71 and a head channel 32, and comprises a passage which the ink flows from the ink cartridge 71 to the head 31. The supply passage 72 is formed of a tube or the like. The supply pump 73 is a tube pump provided on the supply passage 72, which removes the ink from the ink cartridge 71 and sends it to the head 31. The supply pump 73 corresponds to a pressure section that applies pressure to the ink so that the ink flows from the ink cartridge 71 to the head 31. The application of pressure initiates an ink supply to the head 31. The pressure section may also be disposed at the ink cartridge 71 in order to apply pressure to the ink cartridge 71, or alternatively, the ink cartridge 71 may be disposed higher than the head 31 so that ink is supplied to the head 31 using the difference in the water head between the ink cartridge 71 and the head 31. The supply pump 73 is operated during a cleaning process, as described more fully below.

### Structure of Ink Collection Unit

The ink collection unit 80 comprises a first collecting section 81 and a second collecting section 85. The first collecting section 81 includes an ink catcher 82 and a collection passage 83. The second collecting section 85 includes a discharge passage 86, a three-way valve 87, and the waste ink tank 88 serving as a reservoir.

The ink catcher 82 receives the ink ejected from the nozzles 33. The ink catcher 82 is movable between a standby position for use when the printer 1 is performing a printing job, as shown in FIG. 5, and a cleaning position for the cleaning the nozzles, as shown in FIG. 4. The collection passage 83 is connected to the ink catcher 82, through which the ink collected by the ink catcher 82 flows to a tank (not shown). The collection passage 83 is formed of a tube or the like.

With the first collecting section 81 of this structure, the ink that the ink catcher 82 receives during the cleaning of the nozzles 33 flows through the collection passage 83 to the tank, so that the ink is collected.

The discharge passage 86 is connected to the head channel 32 for discharging the ink that has passed to the head 31 that is not ejected from the nozzles 33. In other words, the discharge passage 86 discharges the ink from the head 31 without the ink passing through the nozzles 33. The discharge passage 86 is formed of a tube or the like. The waste ink tank 88 is connected to the discharge passage 86, and stores the ink discharged from the head 31. The discharge passage 86 is connected not only to the waste ink tank 88 but also to the ink cartridge 71. The three-way valve 87 is disposed at the discharge passage 86 upstream from the waste ink tank 88, and is capable of blocking or opening the discharge passage 86. The three-way valve 87 opens the discharge passage 86 so that the ink that passes through the three-way valve 87 reaches either the waste ink tank 88 or the ink cartridge 71.

In the second collecting section 85 of this structure, the ink ejected from the nozzles 33 is blocked from entering the discharge passage 86 by the three-way valve 87, as shown in FIG. 4. On the other hand, when the ink in the head channel 32 is allowed to flow to the waste ink tank 88 or the ink cartridge 71, the three-way valve 87 opens the discharge passage 86, as shown in FIGS. 5 and 6. The three-way valve 87 has three openings through which ink flows, which are denoted by Δ in FIGS. 4 to 6. If the openings are closed, the Δ is filled as shown in FIG. 4, and the ink flow is interrupted. On the other hand, if the openings are opened. the Δ is not filled, as shown in FIG. 5, and the ink flow is allowed. All the three openings of the three-way valve 87 shown in FIG. 4 are closed, so that the ink flow through the three-way valve 87 is completely closed.

### Control of Cleaning

When the viscosity of the ink in the nozzles increases because the ink is not used, the thickened ink may clog the nozzles. This clogging may cause missing dots or degraded image quality. Therefore, the ink that causes the clogging needs to be removed. Furthermore, bubbles or thickened ink may form in the head channel 32, which can interrupt the supply of ink or ejection to/from the nozzles 33. Therefore, the thickened ink and/or bubbles in the head channel 32 need to be removed.

Accordingly, the printer 1 of this embodiment executes the following cleaning operation to solve the above problems. The cleaning process has the following characteristics: (1) pressure is applied to ink so that the ink flows from the ink cartridge 71 to the head 31, and when the ink allowed to flow to the nozzles 33, the discharge passage 86 is blocked in order to clean the nozzles 33; and (2) pressure is applied to ink so that the ink flows from the ink cartridge 71 to the head 31, and when the ink is discharged from the head 31, the discharge passage 86 is opened in order to clean the head channel 32.

The various operations of the printer 1 are controlled by the controller 10. Particularly, in this embodiment, the operations are achieved by the CPU 12 according to programs stored in the memory 13. The programs include code for the following operations.

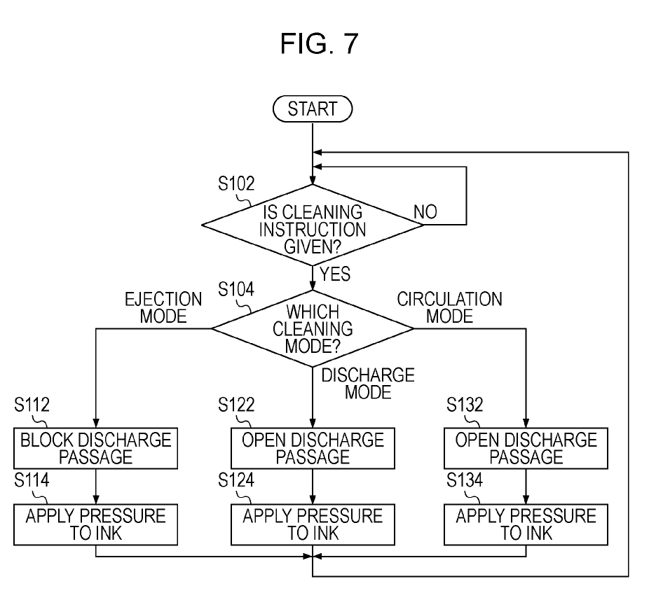

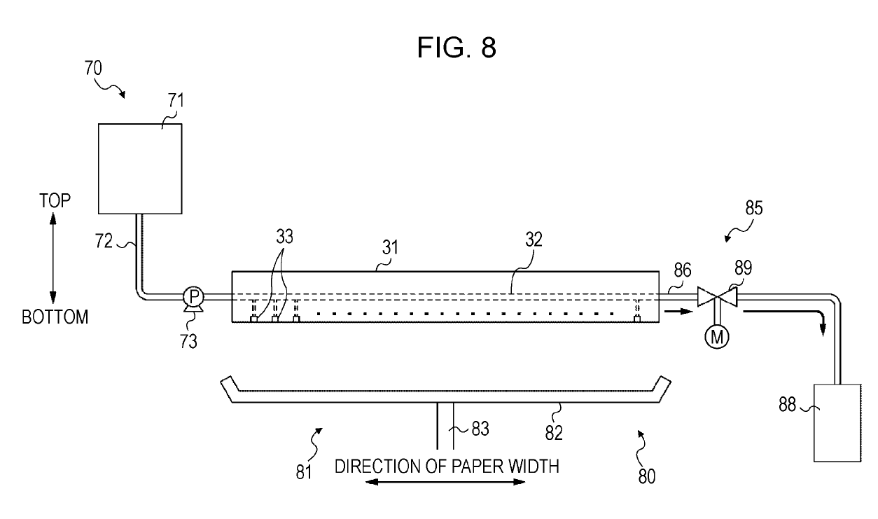

FIG. 7 is a flowchart for describing the cleaning operation of the embodiment. The cleaning process is executed when a cleaning instruction (including information of a cleaning mode described more fully below) is received from the computer 60 (Yes in step S102).

The controller 10 then performs a predetermined operation corresponding to a received cleaning mode. There are three cleaning modes: (1) a mode in which ink is ejected from the nozzles 33 to eliminate any clogs in the nozzles, which is referred to as an ejection mode hereinafter; (2) a mode in which the ink in the head channel 32 is discharged into the waste ink tank 88 to remove any thickened ink in the head channel 32, which is referred to as a discharge mode hereinafter; and (3) a mode in which the ink in the head channel 32 is discharged into the ink cartridge 71 to remove the bubbles in the head channel 32, which is hereinafter referred to as a circulation mode.

The ejection mode is a mode for ejecting ink from the nozzles 33 by applying pressure to the ink using the supply pump 73 with the three-way valve 87 closed. The discharge mode is a mode for letting the ink discharged from the head 31 by the pressure from the supply pump 73 flow to the waste ink tank 88 by opening the discharge passage 86 using the three-way valve 87. The circulation mode is a mode for letting the ink discharged from the head 31 by the pressure from the supply pump 73 flow to the ink cartridge 71 through the discharge passage 86 connected to the ink cartridge 71 by opening the discharge passage 86 using the three-way valve 87.

If the cleaning mode is the ejection mode (step S104), then the controller 10 operates the three-way valve 87 in order to block the discharge passage 86, as shown in FIG. 4 (step S112). The controller 10 then operates the supply pump 73 to apply pressure to the ink for a predetermined time (step S114).

Since the three-way valve 87 blocks the discharge passage 86, the pressurized ink is sent to the nozzles 33 and forcibly ejected from the nozzles 33. The ink ejected from the nozzles 33 is caught by the ink catcher 82 at a cleaning position. The ink on the ink catcher 82 is removed by a suction pump (not shown) and reaches a tank (not shown) through the collection passage 83. Thus, the ink that causes the nozzles to be clogged is removed. The ejection mode can eliminate any clogs caused by the problems around the nozzles 33, such as thickened ink and dust in the nozzles 33. Thus, it is sufficient only to let ink of an amount necessary to discharge the ink in the nozzles 33. Accordingly, the amount of ink ejected in the ejection mode is small.

If the cleaning mode is in the discharge mode (step S104), then the controller 10 operates the three-way valve 87 in order to open the discharge passage 86 so that the ink in the discharge passage 86 flows to the waste ink tank 88, as shown in FIG. 5 (step S122). The controller 10 then operates the supply pump 73 to apply pressure to the ink for a predetermined time (step S124).

Since the three-way valve 87 opens the discharge passage 86, the pressurized ink (including thickened ink) is discharged from the head channel 32. The ink discharged from the head channel 32 flows through the discharge passage 86 and three-way valve 87 into the waste ink tank 88. The ink that has reached the waste ink tank 88 is stored in the waste ink tank 88, and then discarded. Thus, the thickened ink in the head channel 32 is removed.

In the discharge mode, the pressure by the supply pump 73 is controlled so that the pressurized ink is not ejected from the nozzles 33, meaning that the pressure used in the discharge mode is smaller than the amount used in the ejection mode. The reason why no ink is ejected at low pressure is that the resistance in the nozzles 33 is higher than in the discharge passage 86 (this also applies to the circulation mode). The difference in resistance allows the thickened ink or bubbles in the head channel 32 to be more easily discharged than in the ejection mode. The amount of ink discharged in the discharge mode is larger than that in the ejection mode.

The ink may be ejected also from the nozzles 33 at higher pressure. For example, in the case where the ink in both of the nozzles 33 and the head channel 32 has become thickened due to an extended period of time between cleanings, the ink in the nozzles 33 can be ejected while the ink in the head channel 32 is being discharged, thus allowing the thickened ink in the nozzles 33 and the head channel 32 to be discharged.

If the cleaning mode is the circulation mode (step S104), then the controller 10 operates the three-way valve 87 to open the discharge passage 86 so that the ink in the discharge passage 86 flows to the ink cartridge 71, as shown in FIG. 6 (step S132). The controller 10 then operates the supply pump 73 to apply pressure to the ink for a predetermined time (step S134).

Since the three-way valve 87 opens the discharge passage 86, the pressurized ink (including bubbles) is discharged from the head channel 32. The ink discharged from the head channel 32 flows through the discharge passage 86 and the three-way valve 87 into the ink cartridge 71. The ink that has reached the ink cartridge 71 is stored in the ink cartridge 71, where it flows through the supply passage 72 to the head 31. Since the bubbles that have reached the ink cartridge 71 with the ink are located on the ink surface, as shown in FIG. 6, they are not sent to the head 31. As a result, the bubbles in the head channel 32 are removed, and the ink discharged from the head channel 32 is reused.

Repeating the above cleaning operation allows the clogs in the nozzles to be removed and the head channel 32 to be maintained in an appropriate conditions thus ensuring that the ink is properly ejected from the nozzles 33.

### Advantages of Printer of the Embodiment

As described above, the printer 1 according to the embodiment has (1) a supply pump 73 comprising a pressurizing section that applies pressure to the ink so that the ink flows from the ink cartridge 71 to the head 31, (2) a discharge passage 86 which is connected to the head channel 32 through which the ink discharged from the head 31 flows, and (3) a three-way valve 87 (a valve) provided in the discharge passage 86. When the supply pump 73 applies pressure to the ink to send the ink to the nozzles 3 the three-way valve 87 blocks the discharge passage 86. When the supply pump 73 applies pressure to the ink to discharge the ink from the head 31, the three-way valve 87 opens the discharge passage 86. This allows clogs in the nozzles to be eliminated so that the head channel 32 is maintained in an appropriate condition.

Specifically, by sending ink to the nozzles 33 by applying pressure to the ink using the supply pump 73, the three-way valve 87 blocks the discharge passage 86 so that the ink is forcibly ejected from the nozzles 33 in order to remove any clogs in the nozzles 33. Thus, clogged nozzles can be eliminated using a simple structure without using a sealing member (a cap). In order to discharge the ink from the head channel 32, the supply pump 73 applies pressure to the ink, and the three-way valve 87 opens the discharge passage 86 so that the ink is forcibly discharged from the head channel 32. During this process thickened ink and bubbles that have formed in the head channel 32 are removed. Thus, the thickened ink and bubbles are removed from the head channel 32, so that the head channel 32 can be restored to a fully operational condition.

Furthermore, the three-way valve 87 may be operated in order to block or open the discharge passage 86, depending on the particular type of cleaning mode being performed, so that any clogs or bubbles may be eliminated from the nozzles 33 or the head channel 32. Therefore, a printer 1 having an advantageous ink supply and collection system can be achieved. For example, when the ink in the nozzles 33 is greatly thickened but the ink in the head channel 32 is not thickened because the period of time between the last cleaning has not been very long, the ejection mode may be executed. Similarly, when the ink in the head channel 32 is expected to be thickened because a long time has passed since the last cleaning mode, a discharge mode may be executed. When an ejection does not work properly, the error may be caused by bubbles in the head channel 32 and not thickened ink, and the circulation mode may be executed. Thus, the thickened Ink in the head channel 32 may be discharged to the exterior without being returned to the ink cartridge 71, so that the thickened ink can be removed completely. Since the circulation mode is executed when the thickened ink has already been removed, the ink discharged in the circulation mode can be returned to the ink cartridge 71, where it may be separated from the bubbles for reuse.

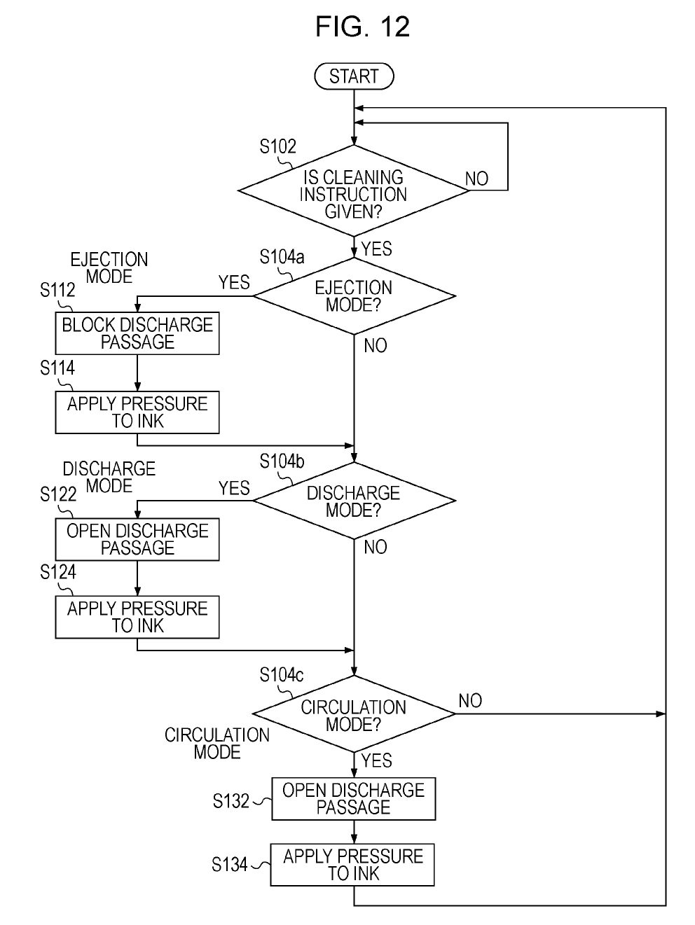

During the cleaning operation, the ejection mode and the discharge mode are executed before the circulation mode is performed wherein the ink is returned to the ink cartridge 71 (FIG. 12) because there is a high possibility of the presence of thickened ink if the operation is performed before the discharge mode and ejection mode are performed. However, both of the ejection mode (step S104a) and the discharge mode (step S104b) may not necessarily be executed. When at least one of the ejection mode (step S104a) and the discharge mode (step S104b) is executed, the mode may be executed before the circulation mode (step S104c). When either the ejection mode (step S104a) or the discharge mode (step S104b) are executed, the ejection mode (step S104a), which consumes little ink, is executed earlier than the other. Then, the clogging would be eliminated without executing the discharge mode (step S104b), so that ink consumption due to the cleaning may be reduced.

### Second Embodiment

In the above embodiment (the first embodiment), the ink discharged from the head channel 32 flows through the discharge passage 86 to the waste ink tank 88 or the ink cartridge 71. As an alternative, the ink may be sent only to the waste ink tank 88 as in a second embodiment described below.

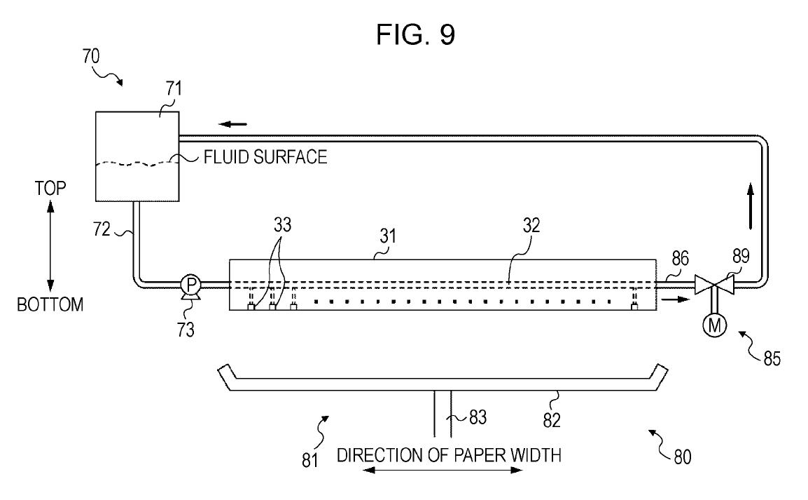

FIG. 8 is a schematic diagram of an ink supply unit 70 and an ink collection unit 80 according to the second embodiment. The second embodiment has a two-way valve 89 in place of the three-way valve 87 of the first embodiment, shown in FIGS. 4, 5, and 6. The discharge passage 86 is connected only to the waste ink tank 88 downstream from the two-way valve 89. Therefore, when the two-way valve 89 blocks the discharge passage 86, the ink discharged from the head channel 32 by the pressure from the supply pump 73 is forcibly ejected from the nozzles 33, as shown in FIG. 4. On the other hand, when the two-way valve 89 opens the discharge passage 86, the ink pressurized by the supply pump 73 is discharged from the head channel 32 and flows through the discharge passage 86 to the waste ink tank 88

The cleaning operation of the second embodiment has an ejection mode and an discharge mode, but no circulation mode. Therefore, as in the second embodiment, if the cleaning mode is the ejection mode, the ink is forcibly ejected from the nozzles 33, so that the ink that causes the clogging is removed, and as a result, clogs in the nozzles can be eliminated. If the cleaning mode is the discharge mode, the ink may be forcibly discharged from the head channel 32, in order to discharge both thickened ink and bubbles. As described in the first embodiment, the pressure by the supply pump 73 in the discharge mode is set lower than that of the ejection mode. Therefore, when the two-way valve 89 opens the discharge passage 86, no ink is ejected from the nozzles 33. Thus, thickened ink and bubbles are discharged from the head channel 32, so that the head channel 32 is restored to an appropriate condition.

In the second embodiment, the discharge passage 86 is not connected to the ink cartridge 71, so that the structure of the ink collection unit 80 can be simplified. The other structure of the second embodiment not described as it is the same as that of the first embodiment.

### Third Embodiment

A third embodiment is different from the above two embodiments. The third embodiment is constructed such that the ink discharged from the head channel 32 flows through the discharge passage 86 to reach only the ink cartridge 71.

FIG. 9 is a schematic diagram of an ink supply unit 70 and an ink collection unit 80 according to the third embodiment. The third embodiment has the two-way valve 89 as in the second embodiment but does not have the waste ink tank 88. The discharge passage 86 is connected only to the ink cartridge 71 downstream from the two-way valve 89. Therefore, when the two-way valve 89 blocks the discharge passage 86, the ink discharged from the head channel 32 by the pressure from the supply pump 73 is forcibly ejected from the nozzles 33 (see FIG. 4). On the other hand, as shown in FIG. 9, when the two-way valve 89 opens the discharge passage 86, the ink pressurized by the supply pump 73 is discharged from the head channel 32 and flows through the discharge passage 86 to the ink cartridge 71

The cleaning mode of the third embodiment has the ejection mode and the circulation mode described above, but not the discharge mode. Therefore, in the third embodiment, if the cleaning mode is the ejection mode, the ink is forcibly ejected from the nozzles 33, so that the ink that causes the clogging is removed, and as a result, any clogs in the nozzles can be eliminated. If the cleaning mode is the circulation mode, the ink is forcibly discharged from the head channel 32 (at that time, bubbles are also discharged). As described in the first embodiment, the pressure of the supply pump 73 in the circulation mode is set to be lower than that of the ejection mode. Therefore, when the two-way valve 89 opens the discharge passage 86, no ink is ejected from the nozzles 33. Since the third embodiment does not have the waste ink tank 88, the thickened ink in the head channel 32 is forcibly ejected from the nozzles 33 in the ejection mode. Thus, thickened ink and bubbles are discharged from the head channel 32, so that the head channel 32 is restored to its proper condition.

### Other Embodiments

Although the fluid ejecting apparatuses has been described according to only a few embodiments above, it is to be understood by those skilled in the art that the foregoing embodiments are used only for ease of understanding and do not limit the invention. It should also be understood that the invention may be changed or modified without departing from the spirit and scope of the invention and that the invention includes its equivalents.

While the fluid ejecting apparatuses according to the embodiments were ink jet printers, the invention may be embodied in fluid ejecting apparatuses that eject another liquids other than ink, including liquid-form matter in which functional particles are dispersed and fluid-form matter such as gel, in addition to liquid or fluids other than liquid, including flowing solid matter that can be ejected. For example, the invention may be applied to a liquid-form-matter ejecting apparatus that ejects liquid-form matter that contains a dispersed or dissolved electrode material or color material for use in manufacturing liquid crystal displays, electroluminescence (EL) displays, and surface emitting displays. The invention may also be applied in a liquid ejecting apparatus that ejects bioorganic matter for use in manufacturing bio chips, and in a liquid ejecting apparatus serving as a precision pipette that ejects a sample of liquid. Other applications include a liquid ejecting apparatuses that eject pinpoint quantities of lubricant in precision machines, such as watches and cameras, and in liquid ejecting apparatuses that ejects transparent resin liquids, such as ultraviolet curable resins, onto a substrate to form a microhemispherical lens (optical lens) for use in optical communication devices, and in liquid ejecting apparatuses that eject etching liquid, such as acid or alkali, to etch a substrate. In addition, the invention may be applied in a fluid-matter ejecting apparatus that ejects gel and a powder ejecting recording apparatus that ejects solid matter or powder such as toner. The invention can be applied to any one of those fluid ejecting apparatuses.

While the printer 1 of the embodiments ejects fluid by applying voltage to the driving element, which may comprise a piezoelectric element, in order to expand and contract the ink chamber, the invention is not so limited, and the invention may be applied to a printer that generates bubbles in the nozzles using a heat generator, and ejects the fluid using the bubbles.

While the printer 1 of the embodiments is a line head printer, the invention is not limited to configuration, and the printer 1 may be a serial printer. In such a case, the head 31 ejects ink onto the paper S while moving in the direction of the paper width, which is shown in FIG. 2B.

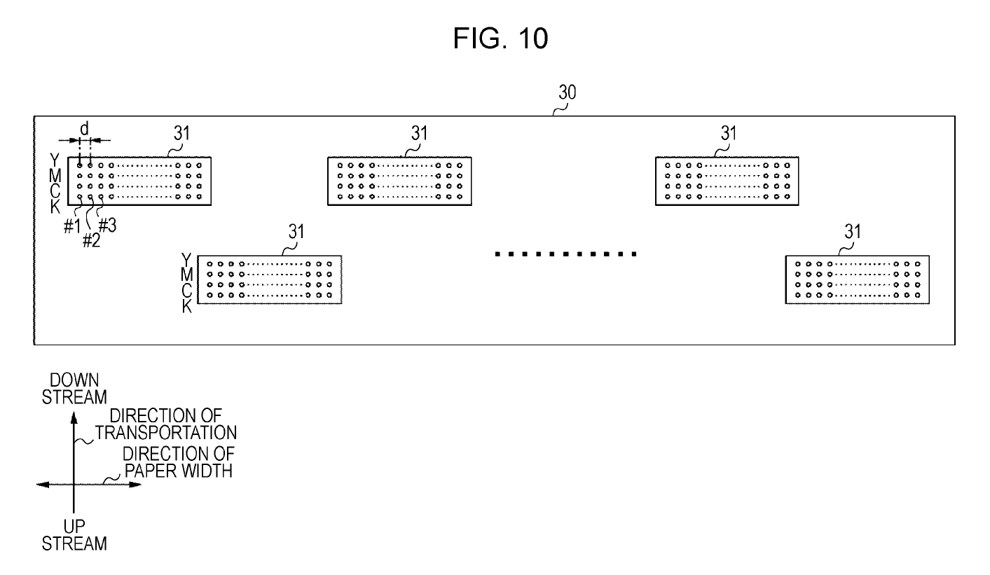

While the head unit 30 of the embodiments has a single head 31, as shown in FIG. 3, the invention is not so limited, and for example, the head unit 40 may have a plurality of staggered heads 31 as shown in FIG. 10. The number of the nozzles of each head 31 shown in FIG. 10 is smaller than the number (n) of the nozzles of the head 31 shown in FIG. 3. FIG. 10 shows another embodiment of the head unit 30.

While the printer 1 of the embodiments has the ink catcher 82 that catches the ink discharged from the nozzles 33 when the three-way valve 87 blocks the discharge passage 86, as shown in FIG. 6, the invention is not limited to that configuration, and for example, the ink catcher 82 may catch the ink removed from the nozzles 33 by a suction pump (not shown) provided in the collection passage 83.

However, when the ink catcher 82 catches the ink discharged from the nozzles 33 by the pressure of the supply pump 73, there is no need to have the suction pump. Therefore, the above embodiments are more preferable because the ink that causes the clogs in the nozzle can be collected using a simple structure.

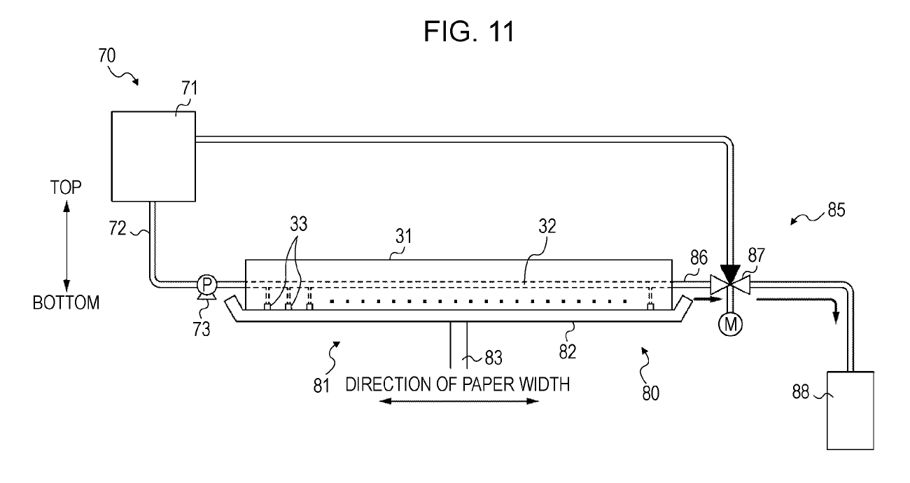

While the above embodiments are constructed such that the moving range of the ink catcher 82 is set from a standby position to a position where it does not come into contact with the head 31 during a cleaning operation, the moving range may be set so that the ink catcher 82 comes into contact with the head 31 during the discharge mode, as shown in FIG. 11. Thus the resistance of the channel in the nozzles 33 becomes higher than that of the discharge passage 86, so that the ink in the head channel 32 can be discharged to the discharge passage 86 without being ejected from the nozzles 33.

What is claimed is:

1. A fluid ejecting apparatus comprising:
a head having a nozzle that is capable of ejecting fluid and a channel through which the fluid flows to the nozzle;
a storing section capable of storing the fluid;
a pressurizing section that is capable of applying pressure to the fluid in the storing section so that the fluid flows from the storing section to the head;
a discharge passage which is connected to the channel through which fluid may be discharged from the head without passing through the nozzle;
a valve provided in the discharge passage;
a reservoir connected to the discharge passage that is located downstream from the valve which is capable of storing the fluid discharged from the head; and
a circulating passage connected to the discharge passage and the storing section at a location that is downstream from the valve;
wherein the fluid ejecting apparatus has an ejection mode wherein the fluid is ejected from the nozzle by applying pressure to the fluid using the pressurizing section with the valve closed, a discharge mode wherein the fluid is ejected from the head by opening the discharge passage and the valve so that the fluid flows from the head to the reservoir, and a circulation mode wherein the fluid is ejected from the head by opening the discharge passage with and valve so that the fluid discharged from the head flows from the head to the storing section through the circulating passage.

2. The fluid ejecting apparatus according to claim 1, wherein the ejection mode and the discharge mode are executed before the circulation mode.

3. The fluid ejecting apparatus according to claim 1, wherein the ejection mode is executed before the discharge mode.

4. The fluid ejecting apparatus according to claim 1, wherein:
the valve is a three-way valve;
the discharge passage is connected to the storing section and the reservoir that stores the fluid discharged from the head at a location that is downstream from the valve; and
the valve opens the discharge passage so that the fluid discharged from the head flows through the discharge passage to either the storing section or the reservoir.

5. The fluid ejecting apparatus according to claim 1, further comprising a catching section that captures the fluid discharged from the head when the liquid is discharged from the nozzle.

6. A method for controlling a fluid ejecting apparatus including a head having a nozzle and a channel through which the fluid flows to the nozzle, a storing section, a pressurizing, a discharge passage including a valve, reservoir, and a circulating passage connected to the storing section, the method comprising:
ejecting the fluid from the nozzle by applying pressure to the fluid in the storing section using the pressurizing section when the valve is closed so that the fluid flows from the storing section to the channel of the head and out the nozzle;
discharging the fluid from the head by applying a pressure on the storing section using the pressurizing section when the valve is open so that the fluid flows from the storing section through the discharge passage and into the reservoir; and
discharging the fluid from the head by applying a pressure on the storing section using the pressurizing section when the valve is open so that the fluid flows from the storing section through the discharge passage, into the circulating passage and back into the storing section.

7. A fluid ejecting apparatus comprising:
a head having a nozzle that is capable of ejecting fluid and a channel through which the fluid flows to the nozzle;
a storing section capable of storing the fluid;
a pressurizing section that is capable of applying pressure to the fluid in the storing section so that the fluid flows from the storing section to the head;
a discharge passage which is connected to the channel through which fluid may be discharged from the head without passing through the nozzle;
a reservoir connected to the discharge passage that is located downstream from the valve which is capable of storing the fluid discharged from the head; and
a circulating passage connected to the discharge passage and the storing section at a location that is downstream from the valve; and
a valve provided in the discharge passage wherein when the valve is closed in an ejection mode the fluid is ejected from the nozzle, wherein when the valve is open to a first opening in a discharge mode where the fluid is ejected from the head into the reservoir, and wherein the valve is open to second opening in a circulation mode where the fluid is ejected from the head into the circulating passage and into the storing section.

8. The fluid ejecting apparatus according to claim 7, wherein the ejection mode and the discharge mode are executed before the circulation mode.

9. The fluid ejecting apparatus according to claim 7, wherein the ejection mode is executed before the discharge mode.

10. The fluid ejecting apparatus according to claim 7, wherein:
the valve is a three-way valve, comprised of a closed mode corresponding to the ejection mode, a first opening mode corresponding to the discharge mode, and a second opening mode corresponding to the circulation mode;
the discharge passage is connected to the storing section and the reservoir that stores the fluid discharged from the head at a location that is downstream from the valve; and
the valve opens the discharge passage so that the fluid discharged from the head flows through the discharge passage to either the storing section or the reservoir.

11. The fluid ejecting apparatus according to claim 7, further comprising a catching section that captures the fluid discharged from the head when the valve is closed and the fluid is ejected from the nozzle.

12. A method for controlling a fluid ejecting apparatus of claim 7, the method comprising:
ejecting the fluid from the nozzle by applying pressure to the fluid in the storing section using the pressurizing section when the valve is closed so that the fluid flows from the storing section to the channel of the head and out the nozzle;
discharging the fluid from the head by applying a pressure on the storing section using the pressurizing section when the valve is open so that the fluid flows from the storing section through the discharge passage and into the reservoir; and
discharging the fluid from the head by applying a pressure on the storing section using the pressurizing section when the valve is open so that the fluid flows from the storing section through the discharge passage, into the circulating passage and back into the storing section.
